(19) United States
(12) Patent Application Publication
(10) Pub. No.: US 2018/0070028 A1
(43) Pub. Date: Mar. 8, 2018

(54) IMAGE SENSOR

(71) Applicant: HIMAX TECHNOLOGIES LIMITED, Tainan City (TW)

(72) Inventors: Yu-Jui HSIEH, Tainan City (TW); Bo-Nan CHEN, Tainan City (TW)

(21) Appl. No.: 15/257,899

(22) Filed: Sep. 6, 2016

(51) Int. Cl. H04N 5/33; H04N 5/225; H04N 9/04

(52) U.S. Cl. CPC H04N 5/33; H04N 9/04; H04N 5/2254; H04N 5/2253

(57) ABSTRACT

An image sensor is provided. The image sensor includes a visible light receiving portion and an infrared receiving portion. The visible light receiving portion is configured to receive a visible light. The infrared receiving portion is configured to receive infrared. The infrared receiving portion includes an infrared photodiode, at least one white filter, and at least one infrared pass filter. At least one white filter is disposed on the infrared photodiode. At least one infrared pass filter is disposed on the infrared photodiode. The infrared is received by the infrared photodiode after passing through at least one white filter and at least one infrared pass filter.

### BACKGROUND

### Field of Invention

The present invention relates to an image sensor. More particularly, the present invention relates to an image sensor having infrared sensing function.

### Description of Related Art

With the development of the access control systems and security systems, biometric technologies using human characteristics to confirm personal identity becomes prevalent. Iris recognition technology is a popular one of the biometric technologies since the iris recognition technology has high reliability. When the iris recognition technology is applied in an electronic device, such as a smart phone, an image sensor capable of receiving visible light and infrared separately is required to implement iris recognition function. A conventional image sensor has two different portions for receiving visible light and infrared separately.

### SUMMARY

The present invention provides an image sensor. The image sensor includes a visible light receiving portion and an infrared receiving portion. The visible light receiving portion is configured to receive a visible light. The infrared receiving portion is configured to receive infrared. The infrared receiving portion includes an infrared photodiode, at least one white filter, and at least one infrared pass filter. At least one white filter is disposed on the infrared photodiode. At least one infrared pass filter is disposed on the infrared photodiode. The infrared is received by the infrared photodiode after passing through at least one white filter and at least one infrared pass filter.

### BRIEF DESCRIPTION OF THE DRAWINGS

The invention can be more fully understood by reading the following detailed description of the embodiment, with reference made to the accompanying drawings as follows:

FIG. 1 is a cross-sectional view of an image sensor according to a first embodiment of the present invention.

FIG. 2 is a cross-sectional view of an image sensor according to a second embodiment of the present invention.

FIG. 3 is a cross-sectional view of an image sensor according to a third embodiment of the present invention.

FIG. 4 is a cross-sectional view of an image sensor according to a fourth embodiment of the present invention.

FIG. 5 is a cross-sectional view of an image sensor according to a fifth embodiment of the present invention.

FIG. 6 is a cross-sectional view of an image sensor according to a sixth embodiment of the present invention.

FIG. 7 is a cross-sectional view of an image sensor according to a seventh embodiment of the present invention.

FIG. 8 is a cross-sectional view of an image sensor according to an eighth embodiment of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

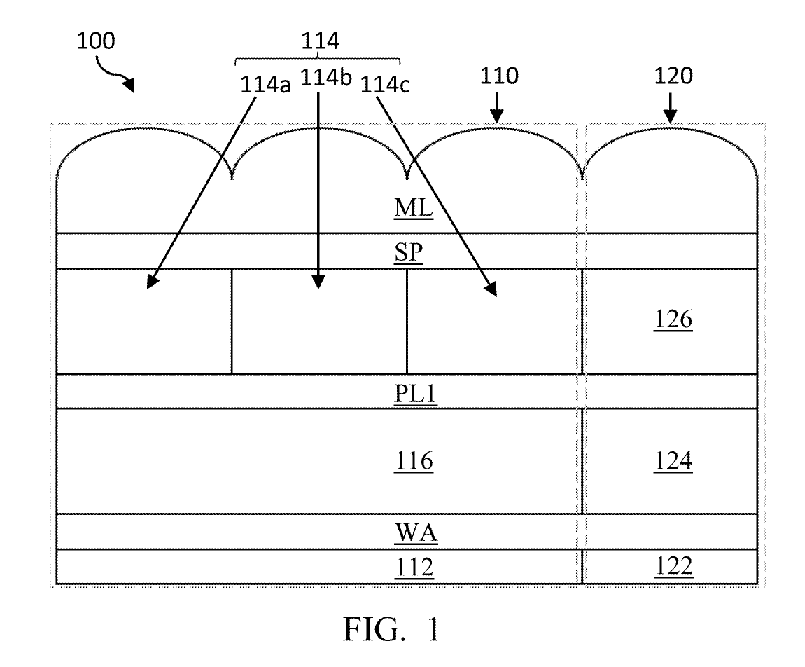

FIG. 1 is a cross-sectional view of an image sensor 100 according to a first embodiment of the present invention. As shown in FIG. 1, the image sensor 100 includes a visible light receiving portion 110 and an infrared receiving portion 120. The visible light receiving portion 110 is configured to receive a visible light, and the infrared receiving portion 120 is configured to receive infrared.

As shown in FIG. 1, the visible light receiving portion 110 includes a visible light sensing layer 112, a color filter 114 and an infrared cutoff filter 116. The color filter 114 and the infrared cutoff filter 116 are disposed on the visible light sensing layer 112 to provide color light to the visible light sensing layer 112, and the visible light sensing layer 112 is configured to receive the visible light to generate main image signals accordingly. In this embodiment, the visible light sensing layer 112 includes at least one photodiode for sensing the color light, and the photodiode may be a complementary metal oxide semiconductor (CMOS) diode. However, embodiments of the present invention are not limited thereto.

The color filter 114 is configured to provide the color light. In this embodiment, the color filter 114 includes a red color filter unit 114a, a blue color filter unit 114b and a green color filter unit 114c, but embodiments of the present invention are not limited thereto. The infrared cutoff filter 116 is configured to cutoff infrared. In other words, the infrared cutoff filter 116 can block the transmission of the infrared, while passing the color light. In this embodiment, the infrared cutoff filter 116 blocks lights having a wavelength greater than 850 nm, but embodiments of the present invention are not limited thereto. Further, in this embodiment, the infrared cutoff filter 116 is disposed between the color filter 114 and the visible light sensing layer 112, but embodiments of the present invention are not limited thereto.

As shown in FIG. 1, the infrared receiving portion 120 includes an infrared sensing layer 122, a white filter 124 and an infrared pass filter 126. The white filter 124 and the infrared pass filter 126 are disposed on the infrared sensing layer 122 to provide the infrared to the infrared sensing layer 122, and the infrared sensing layer 122 is configured to receive the infrared to generate auxiliary image signals accordingly. In this embodiment, the infrared sensing layer 122 includes at least one photodiode for sensing the infrared, and the photodiode may be a CMOS diode. However, embodiments of the present invention are not limited thereto.

The infrared pass filter 126 is configured to cutoff the visible light. In other words, the infrared pass filter 126 can block the transmission of the visible light, while passing the light. In this embodiment, the infrared pass filter 126 blocks lights having a wavelength smaller than 850 nm, but embodiments of the present invention are not limited thereto. The white filter 124 is configured to allow the passage of the infrared. In this embedment, the white filter 124 is a white photoresist, but embodiments of the present invention are not limited thereto. Further, in this embodiment, the white filter 124 is disposed between the infrared pass filter 126 and the infrared sensing layer 122, but embodiments of the present invention are not limited thereto.

As shown in FIG. 1, the visible light receiving portion 110 and the infrared receiving portion 120 further include a wafer WA, a planarization layer PL1, a spacer layer SP and a micro-lens layer ML. The wafer WA is used to provide a substrate on which the infrared cutoff filter 116 and the white filter 124 are formed. In this embodiment, the wafer WA is a glass wafer, but embodiments of the present invention are not limited thereto.

The planarization layer PL1 is formed on the infrared cutoff filter 116 and the white filter 124 to provide a flat surface on which the color filter 114 and the infrared pass filter 126 are disposed. The planarization layer PL1 also provides a good interface to help the color filter 114 and the infrared pass filter 126 to be attached on the planarization layer PL1. It is noted that a thickness of the infrared cutoff filter 116 is substantially equal to that of the white filter 124 in this embodiment.

The spacer layer SP is located on the color filter 114 and the infrared pass filter 126 to provide a flat surface on which the micro-lens layer ML is disposed. It is noted that a thickness of the color filter 114 is substantially equal to that of the infrared pass filter 126 in this embodiment. The micro-lens layer ML is configured to collect the infrared and the visible light. Specifically, when the image sensor 100 is used to sense an object (for example iris), the object is focused though the micro-lens layer ML. Further, focus of the image sensor 100 can be adjusted by varying a thickness of the micro-lens layer ML.

It is noted that the material of the micro-lens layer ML may be epoxy, optical cement, polymethylmethacrylates (PMMAs), polyurethanes (PUs), polydimethylsiloxane (PDMS), or other thermal curing or photo-curing transparent materials, but the present invention is not limited thereto.

In comparison with the conventional image sensor, the infrared received by the image sensor 100 has a smaller loss of intensity since the white filter 124 is disposed in the infrared receiving portion 120 to achieve a decrease of a total thickness of the infrared pass filter 126. Therefore, the infrared received by the image sensor 100 has a better intensity to meet a user's demand.

It is noted that the arrangement of the infrared pass filter 126 and the white filter 124 is not limited to the first embodiment. In some embodiments, the positions of the infrared pass filter 126 and the white filter 124 are exchanged.

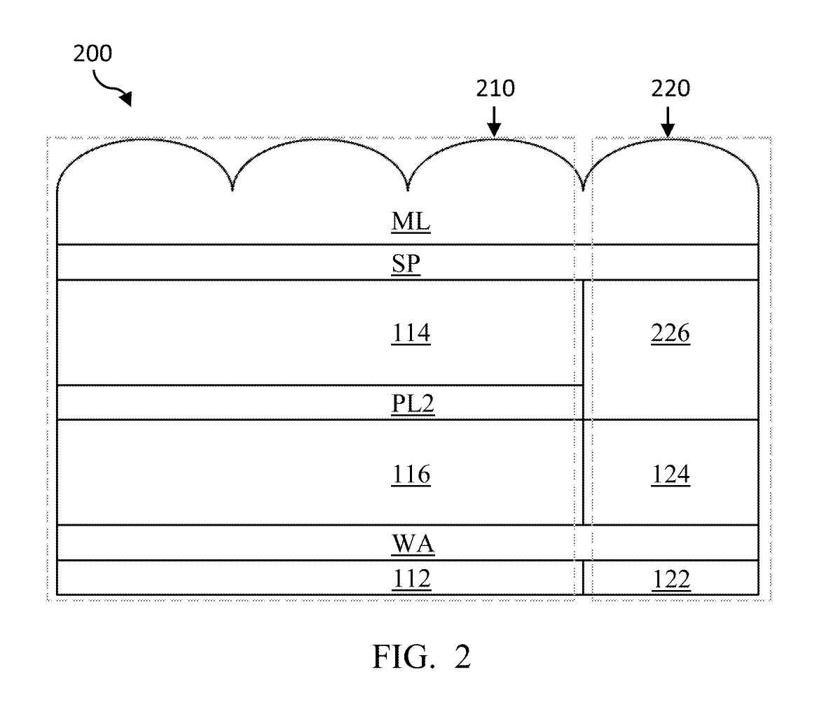

FIG. 2 is a cross-sectional view of an image sensor 200 according to a second embodiment of the present invention. The image sensor 200 includes a visible light receiving portion 210 and an infrared receiving portion 220, in which the visible light receiving portion 210 includes a planarization layer PL2 and the infrared receiving portion 220 includes an infrared pass filter 226. It is noted that the planarization layer PL2 and the infrared pass filter 226 are similar to the planarization layer PL1 and the infrared pass filter 126 respectively. The structure of the image sensor 200 is similar to the structure of the image sensor 100 except that the planarization layer PL2 is only located in the visible light receiving portion 210. It is noted that a sum of a thickness of the color filter 114 and a thickness of the planarization layer PL2 is substantially equal to a thickness of the infrared pass filter 226 in this embodiment. Similar to the image sensor 100, the infrared received by the image sensor 200 has a better intensity to meet a user's demand.

It is noted that the arrangement of the infrared pass filter 226 and the white filter 124 is not limited to the second embodiment. In some embodiments, the positions of the infrared pass filter 226 and the white filter 124 are exchanged.

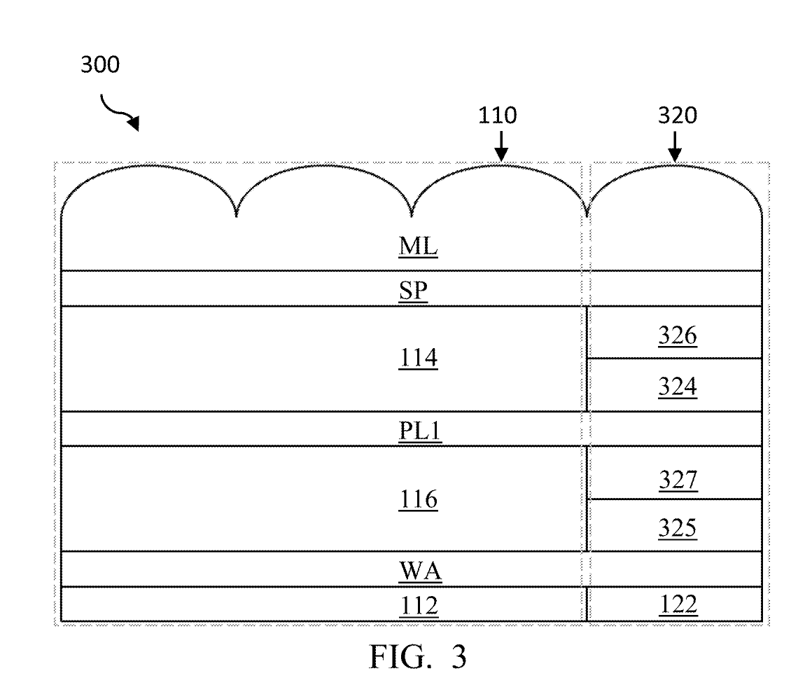

FIG. 3 is a cross-sectional view of an image sensor 300 according to a third embodiment of the present invention. The image sensor 300 includes the visible light receiving portion 110 and an infrared receiving portion 320, in which the infrared receiving portion 320 includes two infrared pass filters 326, 327 and two white filters 324, 325 alternatively stacked on each other. It is noted that the infrared pass filters 326, 327 are similar to the infrared pass filter 126, and the white filters 324, 325 are similar to the white filter 124. The structure of the image sensor 300 is similar to the structure of the image sensor 100 except that the infrared pass filter 126 is replaced with the infrared pass filter 326 and the white filter 324, and the white filter 124 is replaced with the infrared pass filter 327 and the white filter 325. It is noted that a thickness of the color filter 114 is substantially equal to a sum of a thickness of the infrared pass filter 326 and a thickness of the white filter 324 in this embodiment, and a thickness of the infrared cutoff filter 116 is substantially equal to a sum of a thickness of the infrared pass filter 327 and a thickness of the white filter 325 in this embodiment. Similar to the image sensor 100, the infrared received by the image sensor 300 has a better intensity to meet a user's demand.

It is noted that the arrangement of the infrared pass filters 326, 327 and the white filters 324, 325 is not limited to the third embodiment. In some embodiments, the positions of the infrared pass filter 326 and the white filter 324 are exchanged. In some other embodiments, the positions of the infrared pass filter 327 and the white filter 325 are exchanged.

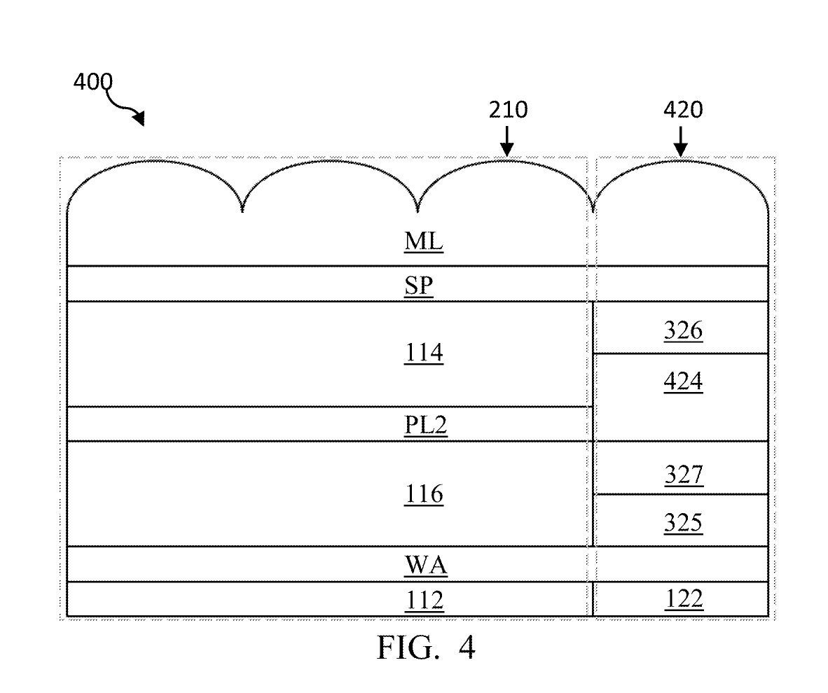

FIG. 4 is a cross-sectional view of an image sensor 400 according to a fourth embodiment of the present invention. The image sensor 400 includes the visible light receiving portion 210 and an infrared receiving portion 420, in which the infrared receiving portion 420 includes a white filter 424. It is noted that the white filter 424 is similar to the white filter 124. The structure of the image sensor 400 is similar to the structure of the image sensor 300 except that the planarization layer PL2 is only located in the visible light receiving portion 210. It is noted that a sum of a thickness of the color filter 114 and a thickness of the planarization layer PL2 is substantially equal to that of a thickness of the infrared pass filter 326 and a thickness of the white filter 424 in this embodiment. Similar to the image sensor 300, the infrared received by the image sensor 400 has a better intensity to meet a user's demand.

It is noted that the arrangement of the infrared pass filters 326, 327 and the white filters 424, 325 is not limited to the fourth embodiment. In some embodiments, the positions of the infrared pass filter 326 and the white filter 424 are exchanged. In some other embodiments, the positions of the infrared pass filter 327 and the white filter 325 are exchanged.

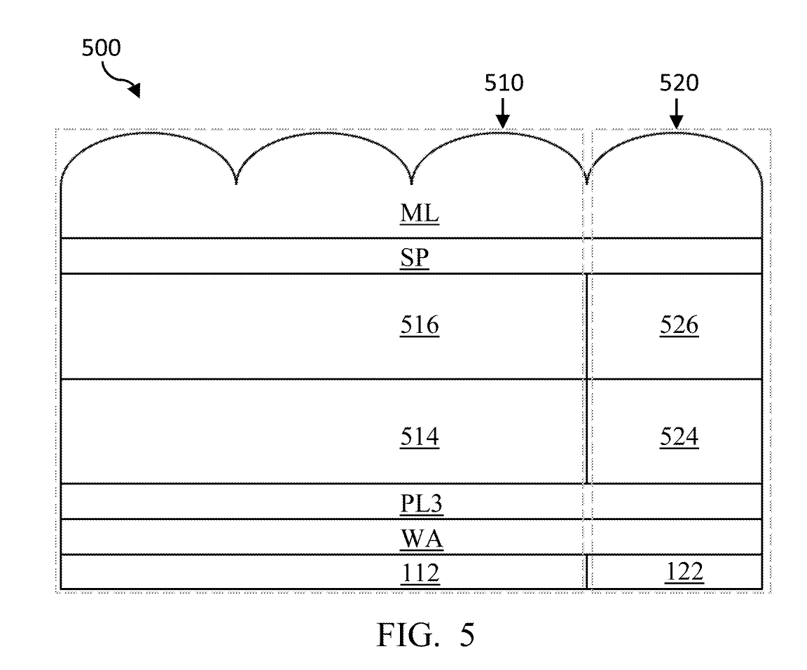

FIG. 5 is a cross-sectional view of an image sensor 500 according to a fifth embodiment of the present invention. The image sensor 500 includes a visible light receiving portion 510 and an infrared receiving portion 520, in which the visible light receiving portion 510 includes a planarization layer PL3, a color filter 514 and an infrared cutoff filter 516 and the infrared receiving portion 520 includes the planarization layer PL3, a white filter 524 and an infrared pass filter 526. It is noted that the planarization layer PL3, the color filter 514, the infrared cutoff filter 516, the white filter 524 and the infrared pass filter 526 are similar to the planarization layer PL1, the color filter 114, the infrared cutoff filter 116, the white filter 124 and the infrared pass filter 126 respectively. The structure of the image sensor 500 is similar to the structure of the image sensor 100, except that the color filter 514 is located between the infrared cutoff filter 516 and the planarization layer PL3. It is noted that a thickness of the color filter 514 is substantially equal to that of the white filter 524 in this embodiment, and a thickness of the infrared cutoff filter 516 is substantially equal to that of the infrared pass filter 526 in this embodiment. Similar to the image sensor 100, the infrared received by the image sensor 500 has a better intensity to meet a user's demand.

It is noted that the arrangement of the infrared pass filter 526 and the white filter 524 is not limited to the fifth embodiment. In some embodiments, the positions of the infrared pass filter 526 and the white filter 524 are exchanged.

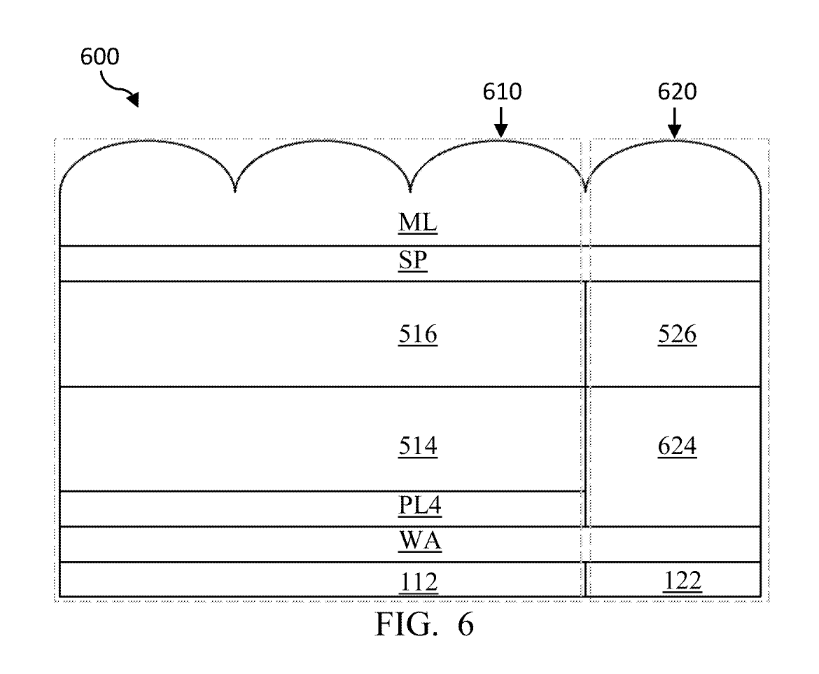

FIG. 6 is a cross-sectional view of an image sensor 600 according to a sixth embodiment of the present invention. The image sensor 600 includes a visible light receiving portion 610 and an infrared receiving portion 620, in which the visible light receiving portion 610 includes a planarization layer PL4 and the infrared receiving portion 620 includes a white filter 624. It is noted that the planarization layer PL4 and the white filter 624 are similar to the planarization layer PL1 and the white filter 124 respectively. The structure of the image sensor 600 is similar to the structure of the image sensor 500 except that the planarization layer PL4 is only located in the visible light receiving portion 610. It is noted that a sum of a thickness of the color filter 514 and a thickness of the planarization layer PL4 is substantially equal to a thickness of the white filter 624 in this embodiment. Similar to the image sensor 500, the infrared received by the image sensor 600 has a better intensity to meet a user's demand.

It is noted that the arrangement of the infrared pass filter 526 and the white filter 624 is not limited to the sixth embodiments. In some embodiments, the positions of the infrared pass filter 526 and the white filter 624 are exchanged.

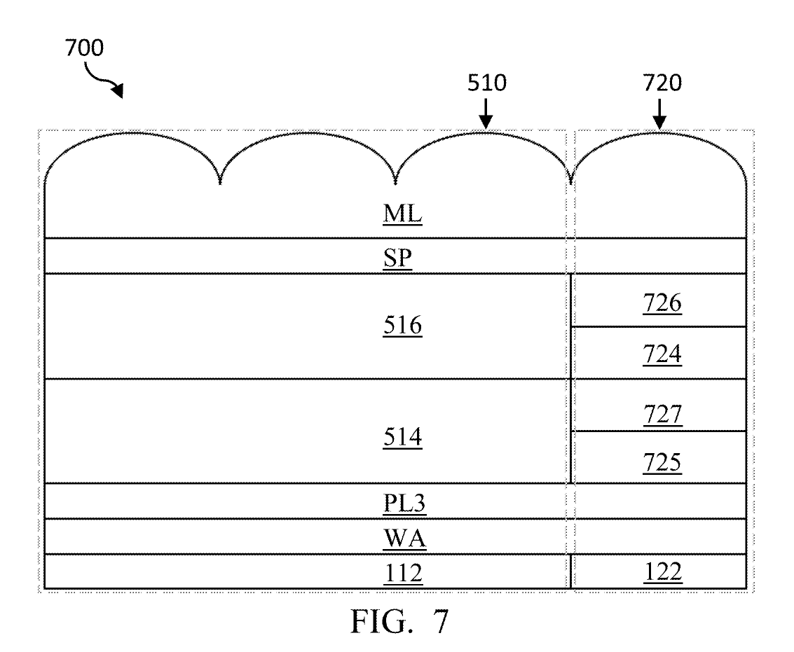

FIG. 7 is a cross-sectional view of an image sensor 700 according to a seventh embodiment of the present invention. The image sensor 700 includes the visible light receiving portion 510 and an infrared receiving portion 720, in which the infrared receiving portion 720 includes two infrared pass filters 726, 727 and two white filters 724, 725 alternatively stacked on each other. It is noted that the infrared pass filters 726, 727 are similar to the infrared pass filter 126, and the white filters 724, 725 are similar to the white filter 124. The structure of the image sensor 700 is similar to the structure of the image sensor 500, except that the infrared pass filter 526 is replaced with the infrared pass filter 726 and the white filter 724, and the white filter 524 is replaced with the infrared pass filter 727 and the white filter 725. It is noted that a thickness of the color filter 514 is substantially equal to a sum of a thickness of the infrared pass filter 727 and a thickness of the white filter 725 in this embodiment, and a thickness of the infrared cutoff filter 516 is substantially equal to a sum of a thickness of the infrared pass filter 726 and a thickness of the white filter 724 in this embodiment. Similar to the image sensor 500, the infrared received by the image sensor 700 has a better intensity to meet a user's demand.

It is noted that the arrangement of the infrared pass filters 726, 727 and the white filters 724, 725 is not limited to the seventh embodiment. In some embodiments, the positions of the infrared pass filter 726 and the white filter 724 are exchanged. In some other embodiments, the positions of the infrared pass filter 727 and the white filter 725 are exchanged.

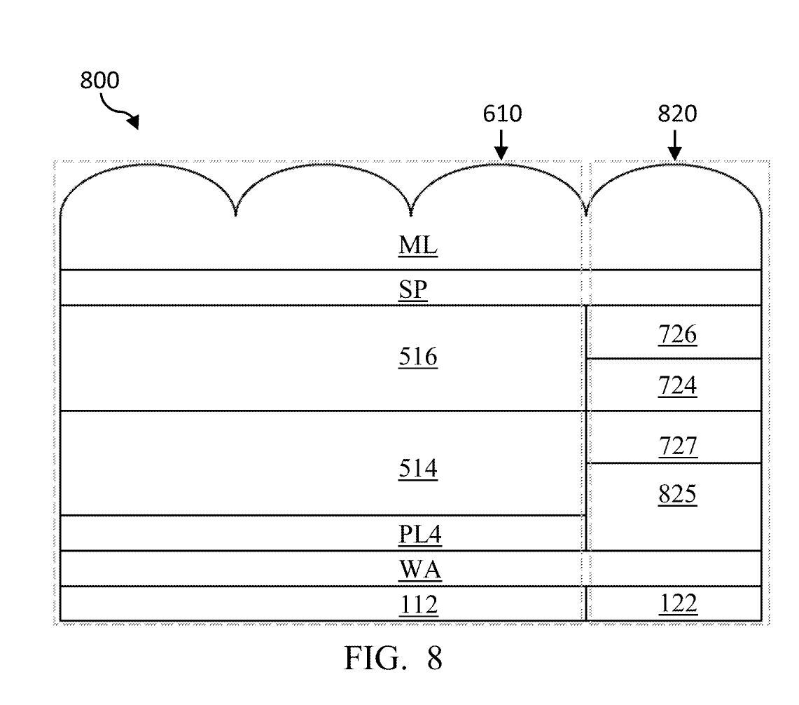

FIG. 8 is a cross-sectional view of an image sensor 800 according to an eighth embodiment of the present invention. The image sensor 800 includes the visible light receiving portion 610 and an infrared receiving portion 820, in which the infrared receiving portion 820 includes a white filter 825. It is noted that the white filter 825 is similar to the white filter 124. The structure of the image sensor 800 is similar to the structure of the image sensor 700 except that the planarization layer PL4 is only located in the visible light receiving portion 610. It is noted that a sum of a thickness of the color filter 514 and a thickness of the planarization layer PL4 is substantially equal to that of a thickness of the infrared pass filter 727 and a thickness of the white filter 825 in this embodiment. Similar to the image sensor 700, the infrared received by the image sensor 800 has a better intensity to meet a user's demand.

It is noted that the arrangement of the infrared pass filters 726, 727 and the white filters 724, 825 is not limited to the eighth embodiment. In some embodiments, the positions of the infrared pass filter 726 and the white filter 724 are exchanged. In some other embodiments, the positions of the infrared pass filter 727 and the white filter 825 are exchanged.

In some embodiments of the present invention, the number of the white filters and the number of the infrared pass filters are both greater than 1, and the white filters and the infrared pass filters are alternatively stacked on the infrared sensing layer, but embodiments of the present invention are not limited thereto.

From the above description, the structure of the image sensor of the present invention may effectively improve the intensity of the infrared received by the image sensor to meet a user's demand, thereby reducing the difficulty of follow-up analysis of the optical signal (for example image signal) on other instruments.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An image sensor, comprising:
a visible light receiving portion configured to receive a visible light; and
an infrared receiving portion configured to receive infrared, wherein the infrared receiving portion comprises:
an infrared photodiode;
at least one white filter disposed on the infrared photodiode; and
at least one infrared pass filter disposed on the infrared photodiode;
wherein the infrared is received by the infrared photodiode after passing through the at least one white filter and the at least one infrared pass filter.

2. The image sensor of claim 1, wherein the visible light receiving portion comprises:
a visible light photodiode;
a color filter disposed on the visible light photodiode; and
an infrared cutoff filter disposed on the visible light photodiode;
wherein the visible light is received by the visible light photodiode after passing through the color filter and the infrared cutoff filter.

3. The image sensor of claim 2, further comprising a wafer located on the infrared photodiode and the visible light photodiode, wherein a first portion of the wafer is located in the visible light receiving portion and a second portion of the wafer is located in the infrared receiving portion.

4. The image sensor of claim 3, wherein the infrared cutoff filter is located between the color filter and the visible light photodiode, and the first portion of the wafer is located between the infrared cutoff filter and the visible light photodiode.

5. The image sensor of claim 3, wherein the color filter is located between the infrared cutoff filter and the visible light photodiode, and the first portion of the wafer is located between the color filter and the visible light photodiode.

6. The image sensor of claim 3, wherein the at least one white filter is located between the at least one infrared pass filter and the infrared photodiode, and the second portion of the wafer is located between the at least one white filter and the infrared photodiode.

7. The image sensor of claim 3, wherein the at least one infrared pass filter is located between the at least one white filter and the infrared photodiode, and the second portion of the wafer is located between the at least one infrared pass filter and the infrared photodiode.

8. The image sensor of claim 2, wherein the color filter comprises a red color filter unit, a green color filter unit, and a blue color filter unit.

9. The image sensor of claim 2, further comprising a planarization layer configured to provide a flat surface on which the color filter is disposed.

10. The image sensor of claim 9, wherein the planarization layer is located in the visible light receiving portion and the infrared receiving portion.

11. The image sensor of claim 9, wherein the planarization layer is located in the visible light receiving portion.

12. The image sensor of claim 1, further comprising a micro-lens layer configured to collect the infrared and the visible light.

13. The image sensor of claim 12, wherein the micro-lens layer is located on the top of the image sensor.

14. The image sensor of claim 12, wherein the micro-lens layer is located in the visible light receiving portion and the infrared receiving portion.

15. The image sensor of claim 12, further comprising a spacer layer configured to provide a flat surface on which the micro-lens layer is disposed.

16. The image sensor of claim 15, wherein the spacer layer is located in the visible light receiving portion and the infrared receiving portion.

17. The image sensor of claim 1, wherein the number of the at least one white filter is greater than 1, and the number of the at least one infrared pass filter is greater than 1, and the white filters and the infrared pass filters are alternatively stacked on the infrared photodiode.
